(19) United States
(12) Patent Application Publication
(10) Pub. No.: US 2024/0289415 A1
(43) Pub. Date: Aug. 29, 2024

(54) SOLVER OF PARTIAL DIFFERENTIAL EQUATION BASED ON NON-VOLATILE MEMORY ARRAY AND METHOD OF SOLVING PARTIAL DIFFERENTIAL EQUATION BASED ON NON-VOLATILE MEMORY ARRAY

(71) Applicant: Peking University, Beijing (CN)

(72) Inventors: Peng HUANG, Beijing (CN); Haozhang YANG, Beijing (CN); Jinfeng KANG, Beijing (CN); Xiaoyan LIU, Beijing (CN)

(21) Appl. No.: 18/044,750

(22) PCT Filed: May 24, 2022
(86) PCT No.: PCT/CN2022/094692

§ 371 Date: Mar. 9, 2023

(30) Foreign Application Priority Data
Oct. 26, 2021 (CN) 202111251725.4

(51) Int. Cl. G06F 17/13

(52) U.S. Cl. CPC G06F 17/13

(57) ABSTRACT

A method of solving a partial differential equation based on a non-volatile memory array includes converting a to-be-solved partial differential equation into an iterative relation, selecting a reusable sub-matrix cell from the iterative coefficient matrix, and storing the sub-matrix cell in the memory array, extracting an input vector from the iteration vector, inputting the input vector into the memory array, updating a portion of the iteration vector by adding an obtained output vector to a portion of the constant vector, extracting the input vector from an updated iteration vector again, and inputting the input vector into the memory array until all elements of the iteration vector are updated to obtain an iteration vector for a next iteration, and ending the iteration when a preset number of iterations is reached or an error is less than a preset range.

### TECHNICAL FIELD

The present disclosure relates to the field of semiconductor memories and integrated circuits, and in particular, to a solver of a partial differential equation based on a non-volatile memory array and a method of solving a partial differential equation based on a non-volatile memory array.

### BACKGROUND

Solving partial differential equations has a wide range of applications in scientific research, including semiconductor device simulation, weather prediction, automobile design, agricultural monitoring, physical research, etc. In a practical application, most partial differential equations are solved by a numerical method, which involves a large number of matrix-vector multiplication operations. When the operation is performed on a traditional Von-Neumann-based computing architecture, due to a bottleneck of data transfer between a central processing unit and memory and a computing mode in which the processing unit and memory are separated, computing speed is greatly limited and a huge energy consumption is required. In addition, an iterative coefficient matrix in solving the partial differential equation has a very large scale, which is square with the scale of mesh grids. Moreover, the elements of the coefficient matrix are highly sparse, and only a few are non-zero. Therefore, the direct storage of the coefficient matrix may cause huge hardware overhead.

In recent years, with the rapid development of 5G and Internet of Things technology, the demand for the solving of partial differential equations has also been growing. A traditional solution may bring a challenge to the hardware resource, computing speed, and energy consumption. Therefore, it is urgently required to develop a solver of partial differential equations with high energy efficiency and hardware utilization, to meet the needs of edge computing.

### SUMMARY

An aspect of the present disclosure provides a method of solving a partial differential equation based on a non-volatile memory array, including: converting a to-be-solved partial differential equation into an iterative relation, wherein the iterative relation includes an iterative coefficient matrix, an iteration vector and a constant vector: selecting a reusable sub-matrix cell from the iterative coefficient matrix, and storing the sub-matrix cell in the non-volatile memory array, wherein a size of the sub-matrix cell is N×3N, and N is an integer greater than 2; extracting an input vector from the iteration vector, and inputting the input vector into the non-volatile memory array, so that the non-volatile memory array performs a product operation of the sub-matrix cell and the input vector, and updating a portion of the iteration vector by adding an obtained output vector to a portion of the constant vector, extracting the input vector from an updated iteration vector again, and inputting the input vector into the non-volatile memory array, until all elements of the iteration vector are updated, so as to obtain an iteration vector for a next iteration; and ending the iteration in response to a preset number of iterations being reached or an error being less than a preset range, wherein an output iteration vector is a solution of the to-be-solved partial differential equation.

Optionally, the method of solving the partial differential equation based on the non-volatile memory array further includes: before extracting an input vector from the iteration vector and inputting the input vector into the non-volatile memory array, classifying every N adjacent elements in the iteration vector into a layer, and respectively adding a zero-filling layer, in which elements are all zero, at a head portion and a tail portion of the iteration vector, so as to form a zero-filled iteration vector: setting a sliding window with a length of 3N on the zero-filled iteration vector, wherein an initial position of the sliding window is a head portion of the zero-filled iteration vector; and classifying every N adjacent elements in the constant vector into a layer, wherein each layer of the constant vector corresponds to the same layer of the iteration vector.

Optionally, the updating a portion of the iteration vector by using an output vector of the non-volatile memory array includes: each time the sliding window slides, extracting the zero-filled iteration vector in the sliding window as the input vector, and inputting the input vector into the non-volatile memory array, so as to obtain the output vector; and adding the output vector to a corresponding layer of the constant vector, so as to replace partial elements in the zero-filled iteration vector, wherein the partial elements are N elements of a second layer in the sliding window when the sliding window acquires the input vector.

Optionally, the sequentially extracting the input vector from the iteration vector based on the sliding window includes: sliding the sliding window and extracting the input vector each time after a layer of the zero-filled iteration vector has been updated.

Optionally, the converting a to-be-solved partial differential equation into an iterative relation includes: converting the to-be-solved partial differential equation into the iteration relation, wherein the iteration relation satisfies:

$$u ( k + 1 ) = R \times u ( k ) + c$$

wherein R is the iterative coefficient matrix, and R has a size of N²×N², a group of sub matrices covering all non-zero elements is separated from the iterative coefficient matrix, and all the sub matrices in the group have a size of N×3N and the same content by appropriately filling elements in sub matrices at a head portion and a tail portion of the group, so that the sub-matrix is the reusable sub-matrix cell: u(k) is a current iteration vector, u(k+1) is a new iteration vector of a next cycle, both u(k) and u(k+1) have a size of N²×1, and k is an integer greater than 1: c is the constant vector, and c has a size of N²×1, wherein N×N is a numerical discrete scale of a solution domain of the partial differential equation, and N is an integer greater than 2.

Optionally, the storing the sub-matrix cell in the non-volatile memory array includes: providing the non-volatile memory array, wherein the providing the non-volatile memory array includes: connecting input terminals of memory cells in the same column of the non-volatile memory array to a column of word lines, connecting output terminals of memory cells in the same row of the non-volatile memory array to a row of bit lines, and storing the sub-matrix cell in the non-volatile memory array by programming and adjusting a conductance value of each memory cell.

Optionally, the performing, by the non-volatile memory array, a product operation of the sub-matrix cell and the input vector includes: converting each element of the input vector into a voltage value, and inputting the voltage value into each column of word lines; determining, by the each memory cell, a magnitude of an output current on the output terminal of the each memory cell through the voltage value on the word line connected to the input terminal and the conductance value of the each memory cell, wherein the magnitude of the output current represents a product value of an element of the input vector and an element of the sub-matrix cell; and collecting the output current of each row of the memory cells to each row of bit lines, and obtaining the output vector through an analog-digital conversion, so that the output vector is a product of the sub-matrix cell and the input vector.

Another aspect of the present disclosure further provides a solver of a partial differential equation based on a non-volatile memory array, including: an iterative relation determination module configured to convert a to-be-solved partial differential equation into an iterative relation, wherein the iterative relation includes an iterative coefficient matrix, an iteration vector and a constant vector: a sub-matrix cell storage module configured to select a reusable sub-matrix cell from the iterative coefficient matrix, and store the sub-matrix cell in a non-volatile memory array, wherein a size of the sub-matrix cell is N×3N, and N is an integer greater than 2: an iteration vector update module configured to extract an input vector from the iteration vector, and input the input vector into the non-volatile memory array, so that the non-volatile memory array performs a product operation of the sub-matrix cell and the input vector, update a portion of the iteration vector by adding an obtained output vector to a portion of the constant vector, extract the input vector from an updated iteration vector again, and input the input vector into the non-volatile memory array, until all elements of the iteration vector are updated, so as to obtain an iteration vector for a next iteration; and an output module configured to end the iteration in response to a preset number of iterations being reached or an error being less than a preset range, wherein an output iteration vector is a solution of the to-be-solved partial differential equation.

Another aspect of the present disclosure further provides an electronic device, including: a processor; and a non-volatile memory with computer-readable instructions stored thereon, wherein the instructions, when executed by the processor, cause the processor to perform the method as described above.

Another aspect of the present disclosure further provides a computer-readable storage medium having computer-readable instructions stored thereon, wherein the instructions, when executed by a processor, cause the processor to perform the method as described above.

### BRIEF DESCRIPTION OF THE DRAWINGS

FIG. 1 schematically shows a general algorithm process of a numerical solution of a partial differential equation problem according to embodiments of the present disclosure;

FIG. 2 schematically shows a flowchart of a method of solving a partial differential equation based on a non-volatile memory array according to embodiments of the present disclosure:

FIG. 3 schematically shows a schematic diagram of a method of segmenting an iterative coefficient matrix according to embodiments of the present disclosure;

FIG. 4 schematically shows a schematic diagram of a non-volatile memory array apparatus according to embodiments of the present disclosure:

FIG. 5 schematically shows a schematic diagram of a method of updating an iteration vector layer by layer according to embodiments of the present disclosure;

FIG. 6 schematically shows a module block diagram of a solver of a partial differential equation based on a non-volatile memory array according to embodiments of the present disclosure.

### DETAILED DESCRIPTION OF EMBODIMENTS

Embodiments of the present disclosure will be described below with reference to the accompanying drawings. It should be understood, however, that these descriptions are merely exemplary and are not intended to limit the scope of the present disclosure. In addition, in the following descriptions, descriptions of well-known structures and technologies are omitted to avoid unnecessarily obscuring the concept of the present disclosure.

Terms used herein are only intended to describe specific embodiments and are not intended to limit the present disclosure. The words “an”, “a (kind of)” and “the” used herein shall also include a meaning of “plurality of” and “multiple”, unless the context clearly indicates otherwise. In addition, terms “including”, “containing”, etc. used herein indicate the presence of the described features, steps, operations and/or components, but do not exclude the presence or addition of one or more other features, steps, operations and/or components.

All terms (including technical and scientific terms) used herein have meanings generally understood by those of ordinary skilled in the art, unless otherwise defined. It should be noted that the terms used herein should be interpreted as having the meaning consistent with the context of the present disclosure, and should not be interpreted in an idealized or overly rigid manner.

Some block diagrams and/or flowcharts are shown in the accompanying drawings. It should be understood that some blocks or a combination thereof in block diagrams and/or flowcharts may be implemented by computer program instructions. The computer program instructions may be provided to a processor of a general-purpose computer, a dedicated-purpose computer, or other programmable data processing apparatuses, so that the instructions, when executed by the processor, may create an apparatus for implementing functions/operations described in the block diagrams and/or flowcharts.

Therefore, a technology of the present disclosure may be implemented in a form of hardware and/or software (including firmware, microcode, etc.). In addition, the technology of the present disclosure may take a form of a computer program product on a computer-readable medium having instructions stored thereon, and the computer program product may be used by or in combination with an instruction execution system. In the context of the present disclosure, the computer-readable medium may be any medium capable of containing, storing, transmitting, propagating, or transmitting the instructions. For example, the computer-readable medium may include, but are not limited to, an electrical, magnetic, optical, electromagnetic, infrared, or semiconductor system, apparatus, device, or a propagation medium. Specific examples of the computer-readable medium include: a magnetic memory device, such as a magnetic tape or hard disk (HDD): an optical memory device, such as an optical disc (CD-ROM); a memory, such as a random access memory (RAM) or flash memory; and/or a wired/wireless communication link.

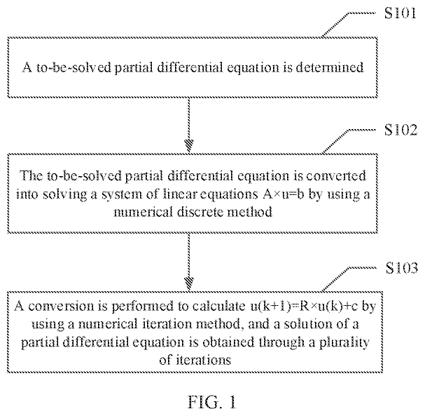

FIG. 1 schematically shows a general algorithm process of a numerical solution of a partial differential equation in the prior art.

If a partial derivative of a multivariate function exists in a differential equation, or if an unknown function is related to several variables and a derivative of the unknown function corresponding to several variables exists in the equation, the differential equation is a partial differential equation, for example, a two-dimensional Poisson's equation:

$$\frac{{\partial }^{2} u}{\partial {x}^{2}} + \frac{{\partial }^{2} u}{\partial {y}^{2}} = f ( x , y ) \qquad ( 1 )$$

In a practical problem in a field of mathematics or physics, a to-be-solved partial differential equation corresponding to the practical problem is determined.

Since a direct analytical solution to the partial differential equation is difficult, the numerical solution is mostly used in a practical application. A process of solving the partial differential equation is shown in FIG. 1. Solution steps include steps S101 to S103.

In step S101, a to-be-solved partial differential equation is determined.

In step S102, the to-be-solved partial differential equation is converted into solving a system of linear equations by using a numerical discrete method:

$$A \times u = b \qquad ( 2 )$$

In the equation, A is a coefficient matrix, and A has a size of N²×N²; b is a vector jointly determined by a boundary condition and a right-side function f(x,y) of the partial differential equation problem, and b has a size of N²×1; u is a to-be-solved vector after a numerical discretization of a solution domain of the partial differential equation, and u has a size of N×1. N is an integer greater than 2, where N×N is a numerical discrete scale of the solution domain of the partial differential equation, and N is an integer greater than 2.

In step S103, an iteration relation is determined by using a numerical iteration method:

$$u ( k + 1 ) = R \times u ( k ) + c \qquad ( 3 )$$

In the equation, R is an iterative coefficient matrix jointly determined by A in the system of linear equations and the numerical iteration method, and R has a size of N²×N². c is a constant vector jointly determined by b and A, and c has a size of N²×1. u(k) is a current iteration vector, u(k+1) is a new iteration vector of a next cycle, and both u(k) and u(k+1) have a size of N²×1, wherein k is an integer greater than 1. After several iterations, a solution of the differential equation may be obtained.

To sum up, a matrix-vector multiplication operation accounts for a large proportion of a whole calculation process in the numerical solution of the partial differential equation. However, since the iterative coefficient matrix R is a large-scale sparse matrix, a large amount of memory may be wasted in the calculation process. Furthermore, when the operation is performed on a traditional Von-Neumann-based computing architecture, due to a bottleneck of data transfer between a central processing unit and memory and a computing mode in which the processing unit and memory are separated, a computing speed is greatly limited and a huge energy consumption is required. Therefore, a solver of partial differential equations with high energy efficiency is urgently required.

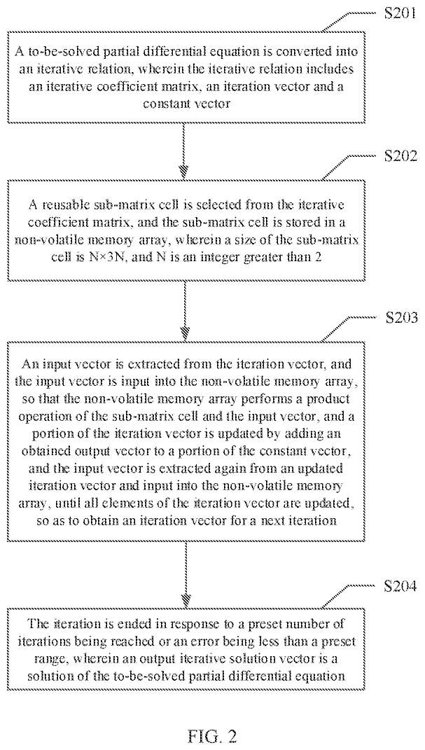

FIG. 2 schematically shows a flowchart of a method of solving a partial differential equation based on a non-volatile memory array according to embodiments of the present disclosure. The method of solving the partial differential equation based on the non-volatile memory array according to embodiments of the present disclosure includes steps S201 to S204.

In step S201, a to-be-solved partial differential equation is converted into an iterative relation, wherein the iterative relation includes an iterative coefficient matrix, an iteration vector, and a constant vector.

Through the above-mentioned method, the iterative relation for solving the partial differential equation problem is obtained, and an iterative coefficient matrix A, an iteration vector u(k), and a constant vector c in the iterative relation are obtained.

In step S202, a reusable sub-matrix cell is selected from the iterative coefficient matrix, and the sub-matrix cell is stored in a non-volatile memory array, wherein a size of the sub-matrix cell is N×3N, and N is an integer greater than 2.

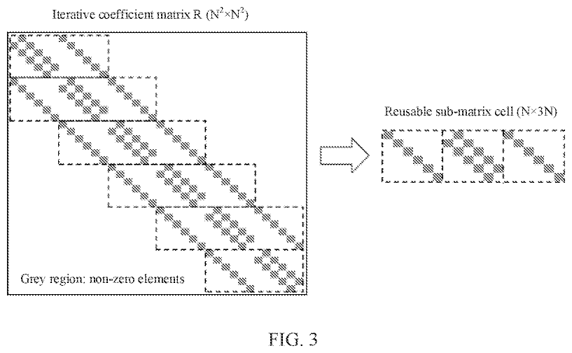

FIG. 3 schematically shows a schematic diagram of a method of segmenting an iterative coefficient matrix according to embodiments of the present disclosure. The iterative coefficient matrix R is jointly determined by the coefficient matrix A in equation (2) and the numerical iteration method. A square relationship exists between the size of the iterative coefficient matrix R and a discrete scale of the solution domain u of the partial differential equation. As shown in FIG. 3, assuming that the solution domain of the partial differential equation of the coefficient matrix A is N×N and the size of the iterative coefficient matrix is N²×N², where a grey region is a non-zero element in the matrix and a white region is a zero element, it may be seen that the iterative coefficient matrix R is highly sparse. The iterative coefficient matrix R shown in FIG. 3 is obtained under an action of a five-point difference discrete and a Jacobian iterative method. A group of sub matrices may be obtained according to a principle of a parallel output per line in discrete lattice points. By appropriately filling elements in sub matrices at a head portion and a tail portion of the group, all sub matrices may have the same size and the same content, and cover all non-zero elements of an original matrix R. Thus, the memory may only need to store a sub-matrix cell with a size of N×3N, and a multiplication of the original large-scale sparse matrix R and the iteration vector u(k) is replaced by a reuse operation of the sub-matrix cell and the iteration vector u(k). A proportion of the non-zero elements in a memory matrix is increased by transforming the original large-scale sparse matrix multiplication into a reuse of a small-scale sub-matrix multiplication, which may greatly improve hardware utilization.

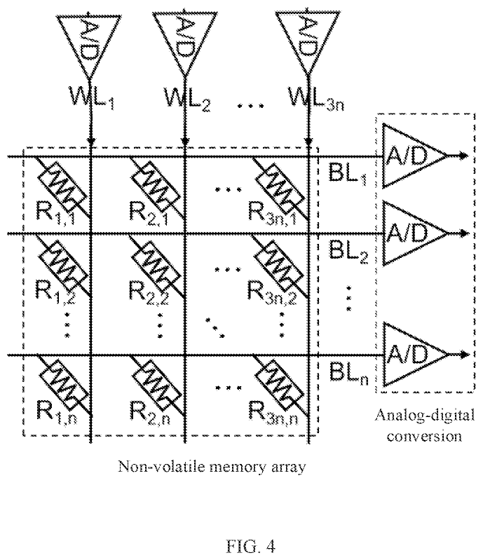

FIG. 4 schematically shows a schematic diagram of a non-volatile memory array apparatus according to embodiments of the present disclosure. According to embodiments of the present disclosure, a memory cell in the non-volatile memory array may be a non-volatile memory. The non-volatile memory refers to a computer memory in which stored data may not disappear when power is turned off. A conductance value of the non-volatile memory may be adjusted by a programming operation. When the same voltage excitation is applied to non-volatile memories with different conductance values, a current flowing through the non-volatile memory reflects a memory state of the non-volatile memory.

According to embodiments of the present disclosure, when the non-volatile memory array is provided, input terminals of memory cells in the same column of the non-volatile memory array are connected to a column of word lines (WLs), and output terminals of memory cells in the same row of the non-volatile memory array are connected to a row of bit lines (BLs). After an element value of an input vector is converted into a voltage by using a digital-to-analog converter, the voltage is input into the non-volatile memory array through WLs. Each memory cell outputs a corresponding magnitude of current according to a voltage value on WL connected to the input terminal and a conductance value of the each memory cell, and the current is collected on each row of BLs. The current on each row of BLs is further converted to a voltage value through an analog-to-digital converter, so as to form an output vector. Accordingly, an operation of a product of a matrix and the input vector is completed.

In step S203, an input vector is extracted from the iteration vector, and the input vector is input into the non-volatile memory array, so that the non-volatile memory array performs a product operation of the sub-matrix cell and the input vector, and a portion of the iteration vector is updated by adding an obtained output vector to a portion of the constant vector, and the input vector is extracted again from an updated iteration vector and input into the non-volatile memory array, until all elements of the iteration vector are updated, so as to obtain an iteration vector for a next iteration.

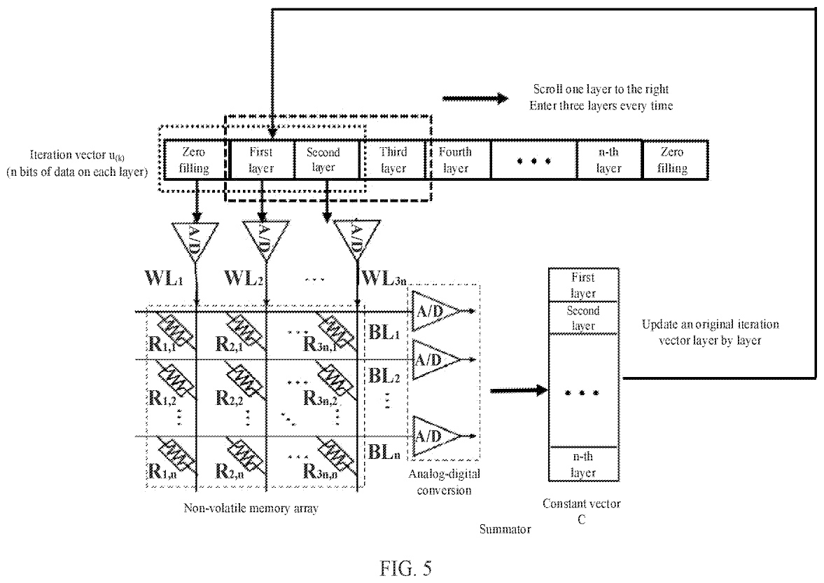

FIG. 5 schematically shows a schematic diagram of a method of updating an iteration vector layer by layer according to embodiments of the present disclosure. Every N adjacent elements in the iteration vector are classified into a layer, and every N adjacent elements in the constant vector are classified into a layer. Each layer of the constant vector corresponds to the same layer of the iteration vector, that is, an N-th layer of the iteration vector corresponds to an N-th layer of the constant vector. Zero-filling layers, in which elements are all zero, are respectively added at a head portion and a tail portion of the iteration vector, so as to form a zero-filled iteration vector. A sliding window with a length of 3N is set on the zero-filled iteration vector. An initial position of the sliding window is a head portion of the zero-filled iteration vector. A vector element in the sliding window is acquired as the input vector, and the input vector is converted into a corresponding voltage value and then input into the non-volatile memory array so that the non-volatile memory array performs the product operation of the sub-matrix cell and the input vector. An obtained output current is converted into an output vector. Since the sub-matrix cell has a size of N×3N and the input vector has a size of 3N×1, the output vector has a size of N×1. Therefore, the output vector may only be added to a layer of constant vectors, and only a portion of the iteration vector may be updated. When a middle layer in which a current sliding window is located is the N-th layer of the iteration vector, the added constant vector is also the N-th layer. The above-mentioned portion of the iteration vector refers to the middle layer in which the current sliding window is located. For example, when the sliding window is located at the head portion, the input vectors are the zero-filling layer, a first-layer iteration vector, and a second-layer iteration vector. The first-layer iteration vector is updated after the output vector is added with a first-layer constant vector. At this time, the sliding window slides. The obtained input vector includes an updated first-layer iteration vector, the second-layer iteration vector, and a third-layer iteration vector. When the sliding window is located at the tail portion, the input vectors are an (N−1)-th-layer iteration vector, an N-th-layer iteration vector, and the zero-filling layer. The N-th-layer iteration vector is updated after the input vector is added with an N-th-layer constant vector. In this way, when the sliding window slides from the head portion to the tail portion of the zero-filled iteration vector, each element in the iteration vector has been updated, so that an iteration vector required for a new round of iteration is obtained, and the current iteration is completed.

In step S204, the iteration is ended in response to a preset number of iterations being reached or an error being less than a preset range, wherein an output iteration vector is a solution of the to-be-solved partial differential equation.

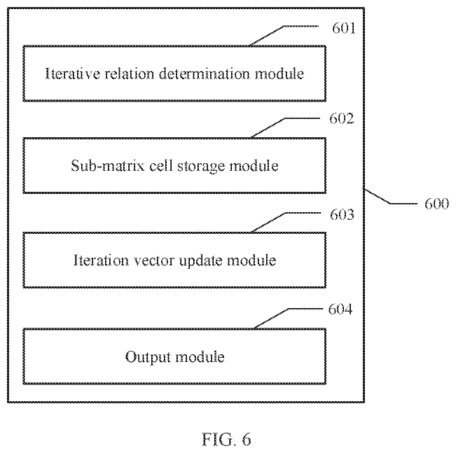

FIG. 6 schematically shows a block diagram of a solver of a partial differential equation according to embodiments of the present disclosure.

As shown in FIG. 6, a solver (600) of a partial differential equation based on a non-volatile memory array includes an iterative relation determination module (601), a sub-matrix cell storage module (602), an iteration vector update module (603), and an output module (604).

The iterative relation determination module (601) is used to convert a to-be-solved partial differential equation into an iterative relation, wherein the iterative relation includes an iterative coefficient matrix, an iteration vector, and a constant vector.

The sub-matrix cell storage module (602) is used to select a reusable sub-matrix cell from the iterative coefficient matrix, and store the sub-matrix cell in a non-volatile memory array, wherein a size of the sub-matrix cell is N×3N, and N is an integer greater than 2.

The iteration vector update module (603) is used to extract an input vector from the iteration vector, and input the input vector into the non-volatile memory array, so that the non-volatile memory array performs a product operation of the sub-matrix cell and the input vector, update a portion of the iteration vector by adding an obtained output vector to a portion of the constant vector, extract the input vector from an updated iteration vector again, and input the input vector into the non-volatile memory array, until all elements of the iteration vector are updated, so as to obtain an iteration vector for a next iteration.

The output module (604) is used to end the iteration in response to a preset number of iterations being reached or an error being less than a preset range, wherein an output iteration vector is a solution of the to-be-solved partial differential equation.

According to embodiments of the present disclosure, any number of or at least some functions of any number of the iterative relation determination module (601), the sub-matrix cell storage module (602), the iteration vector update module (603), and the output module (604) may be implemented in a module. Any one or more of modules, sub modules, units and sub units according to embodiments of the present disclosure may be split into a plurality of modules for implementation. Any one or more of the modules, sub modules, units and sub units according to embodiments of the present disclosure may be at least partially implemented as hardware circuits, such as a field programmable gate array (FPGA), a programmable logic array (PLA), a system on chip, a system on substrate, a system on package, and an application specific integrated circuit (ASIC), or may be implemented by hardware or firmware in any other reasonable way of integrating or encapsulating a circuit, or may be implemented by any one or an appropriate combination of any number of three implementation methods of software, hardware and firmware. Alternatively, one or more of the modules, the sub modules, the units and the sub units according to embodiments of the present disclosure may be at least partially implemented as a computer program module. The computer program module, when run, may perform a corresponding function.

For example, any number of the iterative relation determination modules (601), the sub-matrix cell storage modules (602), the iteration vector update modules (603), and the output modules (604) may be combined in a module/unit/sub unit for implementation, or any one of the modules/units/sub units may be split into a plurality of modules/units/sub units. Alternatively, at least some functions of one or more of the modules/units/sub units may be combined with at least some functions of other modules/units/sub units and implemented in a module/unit/sub unit. According to embodiments of the present disclosure, at least one of the iterative relation determination module (601), the sub-matrix cell storage module (602), the iteration vector update module (603), and the output module (604) may be at least partially implemented as hardware circuits, such as a field programmable gate array (FPGA), a programmable logic array (PLA), a system on chip, a system on substrate, a system on package, and an application specific integrated circuit (ASIC), or may be implemented by hardware or firmware in any other reasonable way of integrating or encapsulating the circuit, or may be implemented by any one or an appropriate combination of any number of the three implementation methods of software, hardware and firmware. For example, a portion of the iteration vector update module (603) according to embodiments of the present disclosure may be implemented by the hardware non-volatile memory array, and a portion of the iteration vector update module (603) may be implemented by a computer software combination. Alternatively, at least one of the iterative relation determination module (601), the sub-matrix cell storage module (602), the iteration vector update module (603), and the output module (604) may be at least partially implemented as a computer program module. The computer program module, when run, may perform a corresponding function. Those skilled in the art may understand that the features recorded in various embodiments and/or claims of the present disclosure may be combined and/or incorporated in many ways, even if the combination or incorporation is not explicitly recorded in the present disclosure. In particular, without departing from the spirit and teaching of the present disclosure, the features recorded in various embodiments and/or claims of the present disclosure may be combined and/or incorporated in many ways. All the combinations and/or incorporations fall within the scope of the present disclosure.

According to embodiments of the present disclosure, a computer-readable storage medium may be a non-volatile computer-readable storage medium. In the present disclosure, the computer-readable storage medium may be any tangible medium containing or storing a program, and the program may be used by or in combination with an instruction execution system, apparatus or device. For example, according to embodiments of the present disclosure, the computer-readable storage medium may include a plurality of non-volatile memories.

The above-mentioned specific embodiments have described in detail for the objectives, technical solutions and advantages of the present disclosure. It should be noted that the above are only specific embodiments of the present disclosure and are not intended to limit the present disclosure. Any modifications, equivalent substitutions, improvements, and the like made within the spirit and scope of the present disclosure shall be included in the scope of protection of the present disclosure.

1. A method of solving a partial differential equation based on a non-volatile memory array, comprising:
converting a to-be-solved partial differential equation into an iterative relation, wherein the iterative relation comprises an iterative coefficient matrix, an iteration vector and a constant vector;
selecting a reusable sub-matrix cell from the iterative coefficient matrix, and storing the sub-matrix cell in the non-volatile memory array, wherein a size of the sub-matrix cell is N×3N, and N is an integer greater than 2;
extracting an input vector from the iteration vector, and inputting the input vector into the non-volatile memory array, so that the non-volatile memory array performs a product operation of the sub-matrix cell and the input vector, updating a portion of the iteration vector by adding an obtained output vector to a portion of the constant vector, extracting the input vector from an updated iteration vector again, and inputting the input vector into the non-volatile memory array, until all elements of the iteration vector are updated, so as to obtain an iteration vector for a next iteration; and
ending the iteration in response to a preset number of iterations being reached or an error being less than a preset range, wherein an output iteration vector is a solution of the to-be-solved partial differential equation.

2. The method of solving the partial differential equation based on the non-volatile memory array according to claim 1, further comprising: before extracting an input vector from the iteration vector and inputting the input vector into the non-volatile memory array,
classifying every N adjacent elements in the iteration vector into a layer, and respectively adding a zero-filling layer, in which elements are all zero, at a head portion and a tail portion of the iteration vector, so as to form a zero-filled iteration vector;
setting a sliding window with a length of 3N on the zero-filled iteration vector, wherein an initial position of the sliding window is a head portion of the zero-filled iteration vector; and
classifying every N adjacent elements in the constant vector into a layer, wherein each layer of the constant vector corresponds to the same layer of the iteration vector.

3. The method of solving the partial differential equation based on the non-volatile memory array according to claim 2, wherein the updating a portion of the iteration vector by using an output vector of the non-volatile memory array comprises:
each time the sliding window slides, extracting the zero-filled iteration vector in the sliding window as the input vector, and inputting the input vector into the non-volatile memory array, so as to obtain the output vector; and
adding the output vector to a corresponding layer of the constant vector, so as to replace partial elements in the zero-filled iteration vector, wherein the partial elements are N elements of a second layer in the sliding window when the sliding window acquires the input vector.

4. The method of solving the partial differential equation based on the non-volatile memory array according to claim 3, wherein the sequentially extracting the input vector from the iteration vector based on the sliding window comprises:
sliding the sliding window and extracting the input vector each time after a layer of the zero-filled iteration vector has been updated.

5. The method of solving the partial differential equation based on the non-volatile memory array according to claim 1, wherein the converting a to-be-solved partial differential equation into an iterative relation:
converting the to-be-solved partial differential equation into the iteration relation, wherein the iteration relation satisfies:
u₍ₖ₊₁₎=R×u₍ₖ₎+c
wherein R is the iterative coefficient matrix, R has a size of N²×N², a group of sub matrices covering all non-zero elements is separated from the iterative coefficient matrix, and all the sub matrices in the group have a size of N×3N and the same content by appropriately filling elements in sub matrices at a head portion and a tail portion of the group, so that the sub-matrix is the reusable sub-matrix cell; u₍ₖ₎ is a current iteration vector, u₍ₖ₊₁₎ is a new iteration vector of a next cycle, both u₍ₖ₎ and u₍ₖ₊₁₎ have a size of N²×1, and k is an integer greater than 1; c is the constant vector, and c has a size of N²×1, wherein N×N is a numerical discrete scale of a solution domain of the partial differential equation, and N is an integer greater than 2.

6. The method of solving the partial differential equation based on the non-volatile memory array according to claim 1, wherein the storing the sub-matrix cell in the non-volatile memory array comprises:
providing the non-volatile memory array, wherein the providing the non-volatile memory array comprises: connecting input terminals of memory cells in the same column of the non-volatile memory array to a column of word lines, connecting output terminals of memory cells in the same row of the non-volatile memory array to a row of bit lines, and storing the sub-matrix cell in the non-volatile memory array by programming and adjusting a conductance value of each memory cell.

7. The method of solving the partial differential equation based on the non-volatile memory array according to claim 6, wherein the performing, by the non-volatile memory array, a product operation of the sub-matrix cell and the input vector comprises:
converting each element of the input vector into a voltage value, and inputting the voltage value into each column of word lines;
determining, by the each memory cell, a magnitude of an output current on the output terminal of the each memory cell through the voltage value on the word line connected to the input terminal and the conductance value of the each memory cell, wherein the magnitude of the output current represents a product value of an element of the input vector and an element of the sub-matrix cell; and
collecting the output current of each row of the memory cells to each row of bit lines, and obtaining the output vector through an analog-digital conversion, so that the output vector is a product of the sub-matrix cell and the input vector.

8. A solver of a partial differential equation based on a non-volatile memory array, comprising:
an iterative relation determination module configured to convert a to-be-solved partial differential equation into an iterative relation, wherein the iterative relation comprises an iterative coefficient matrix, an iteration vector and a constant vector;
a sub-matrix cell storage module configured to select a reusable sub-matrix cell from the iterative coefficient matrix, and store the sub-matrix cell in the non-volatile memory array, wherein a size of the sub-matrix cell is N×3N, and N is an integer greater than 2;
an iteration vector update module configured to extract an input vector from the iteration vector, and input the input vector into the non-volatile memory array, so that the non-volatile memory array performs a product operation of the sub-matrix cell and the input vector, update a portion of the iteration vector by adding an obtained output vector to a portion of the constant vector, extract the input vector from an updated iteration vector again, and input the input vector into the non-volatile memory array, until all elements of the iteration vector are updated, so as to obtain an iteration vector for a next iteration; and
an output module configured to end the iteration in response to a preset number of iterations being reached or an error being less than a preset range, wherein an output iteration vector is a solution of the to-be-solved partial differential equation.

9. An electronic device, comprising:
a processor; and
a non-volatile memory with computer-readable instructions stored thereon, wherein the instructions, when executed by the processor, cause the processor to perform the method according to claim 1.

10. A computer-readable storage medium having computer-readable instructions stored thereon, wherein the instructions, when executed by a processor, cause the processor to perform the method according to claim 1.
